(19) United States
(12) Patent Application Publication
(10) Pub. No.: US 2025/0187520 A1
(43) Pub. Date: Jun. 12, 2025

(54) TOP-OPENING AND REAR-OPENING VEHICLE-MOUNTED REFRIGERATOR AND CONTROL METHOD THEREFOR

(71) Applicant: GUANGDONG ICECO ENTERPRISE CO., LTD, Zhongshan (CN)

(72) Inventors: SHAOHUI LUO, Zhongshan (CN); YANG LIU, Zhongshan (CN); YONGGANG ZHANG, Zhongshan (CN); MENGRU HAN, Zhongshan (CN)

(21) Appl. No.: 18/945,930

(22) Filed: Nov. 13, 2024

Related U.S. Application Data
(63) Continuation of application No. PCT/CN2024/090600, filed on Apr. 29, 2024.

(30) Foreign Application Priority Data
Dec. 7, 2023 (CN) 202311673931.3

(51) Int. Cl. B60N 3/10; F25D 23/04

(52) U.S. Cl. CPC B60N 3/104; F25D 23/04; F25D 2700/02

(57) ABSTRACT

The invention involves the field of vehicle-mounted refrigerators, particularly a top-opening and rear-opening vehicle-mounted refrigerator and a control method therefor. The top-opening and rear-opening vehicle-mounted refrigerator comprises a refrigerator body. A top and a rear end of the refrigerator body are each provided with an opening. A top cover is arranged at the opening on the top end of the refrigerator body. A drawer is further comprised. The drawer comprises a body and a drawer panel. An accommodation cavity is arranged in the refrigerator body. The body is arranged in the accommodation cavity and is slidably connected to the refrigerator body in a front-back direction. The drawer panel is connected at the opening on the rear end of the refrigerator body in a covering manner. The top-opening and rear-opening vehicle-mounted refrigerator has the advantages of being capable of simultaneously providing convenience for front-seat and rear-seat passengers to take items.

### CROSS-REFERENCE TO RELATED APPLICATIONS

This application is a continuation of co-pending International Patent Application No. PCT/CN2024/090600, filed on Apr. 29, 2024, which claims the priority and benefit of Chinese patent application number 2023116739313, filed on Dec. 7, 2023 with China National Intellectual Property Administration, the entire contents of which are incorporated herein by reference.

### TECHNICAL FIELD

The present invention relates to the field of vehicle-mounted refrigerators, and in particular to a top-opening and rear-opening vehicle-mounted refrigerator and a control method therefor.

### BACKGROUND

Vehicle-mounted refrigerators are generally opened either by providing a top flip cover or by providing a drawer, but the flip cover and the drawer are not provided simultaneously.

A flip-top vehicle-mounted refrigerator is generally placed at an armrest in a vehicle, where a refrigerator flip cover is flipped backwards to facilitate two passengers sitting next to the armrest to open the refrigerator, and the refrigerator may be arranged at an armrest at a driver's seat or may also be arranged at an armrest at a rear seat. For example, a Chinese invention patent with the publication number of CN203511399U discloses an embedded refrigerator at an armrest at a rear seat, which comprises a refrigerator body, where a refrigerator door is hinged to a top portion of the refrigerator body, and the refrigerator door can be flipped backwards to be opened to expose items in the refrigerator body. If this structure is placed at a driver's seat, it can be convenient for front-seat passengers to access items from the refrigerator, but it is inconvenient for rear-seat passengers to access the items. If this structure is placed at an armrest at a rear seat, it is difficult for the front-seat passengers to access the items in the refrigerator.

Drawer-type refrigerators are generally mounted at an armrest at a driver's seat, where a refrigerator drawer is pulled out backwards, which can facilitate rear-seat passengers to open the refrigerator. For example, a Chinese invention patent with the publication number of CN217110130U discloses a vehicle-mounted refrigerator provided with a quick-release drawer apparatus, wherein a refrigerator body assembly comprises an inner container, and the drawer slides in and out in conjunction with the inner container by means of drawer guide rails. This structure makes it inconvenient for front-seat passengers to access items.

A problem existing in the prior art is that it is impossible to simultaneously provide convenience for front-seat and rear-seat passengers to take items.

### SUMMARY

In order to solve the above technical problem, the objective of the present invention is to provide a top-opening and rear-opening vehicle-mounted refrigerator and a control method therefor, which can simultaneously provide convenience for front and rear passengers to take items.

The technical solution employed in the present invention to solve the problem is: a top-opening and rear-opening vehicle-mounted refrigerator, comprising a refrigerator body. A top end and a rear end of the refrigerator body are each provided with an opening. A top cover is arranged at the opening on the top end of the refrigerator body. A drawer is further comprised. The drawer comprises a body and a drawer panel. An accommodation cavity is arranged in the refrigerator body. The body is arranged in the accommodation cavity and is slidably connected to the refrigerator body in a front-back direction. The drawer panel is connected at the opening on the rear end of the refrigerator body in a covering manner.

As a further improvement of the above technical solution, a rear end of the top cover is hinged to the refrigerator body. A front portion of the top cover is provided with a connection portion. A latch is arranged on the refrigerator body. The latch is detachably connected to the connection portion. In the present technical solution, the top cover is flipped in a backward direction. When mounted at a front seat, the top-opening and rear-opening vehicle-mounted refrigerator of the present invention is opened backward, without hindering a driver from driving a vehicle.

As a further improvement of the above technical solution, the latch comprises a latch tongue and a power mechanism. A first sensor is arranged on the refrigerator body. The first sensor is used to sense whether the drawer is open. A controller is further comprised. The first sensor and the power mechanism are both electrically connected to the controller. The power mechanism is used to drive the latch tongue to be connected to or disconnected from the connection portion. Whether the drawer is open is sensed by the first sensor. When the drawer is open, the controller controls the power mechanism to drive the latch tongue to be connected to the connection portion, such that a user cannot open the top cover, thereby preventing the drawer and the top cover from being opened simultaneously. If the top cover is opened when the drawer of the vehicle-mounted refrigerator is open, structures such as drawer slide rails and a refrigeration system in the accommodation cavity are exposed, and foreign objects falling from the opening on the top end of the refrigerator body may cause damage to the vehicle-mounted refrigerator.

As an optional technical solution, the first sensor is a Hall sensor. The power mechanism is an electromagnet. The connection portion is a blind hole. The power mechanism can attract or repel the latch tongue, so as to control the latch tongue to translate relative to the connection portion, thereby causing the latch tongue to be inserted into or detached from the connection portion.

As a further improvement of the above technical solution, a connection position is arranged on the drawer. A snap-fit member is arranged on the refrigerator body. The snap-fit member is detachably connected to the connection position.

As a further improvement of the above technical solution, the snap-fit member comprises a snap-fit protrusion and a driving mechanism. A second sensor is arranged on the refrigerator body. The second sensor is used to sense whether the top cover is open. A controller is further comprised. The second sensor and the driving mechanism are both electrically connected to the controller. The driving mechanism is used to drive the snap-fit protrusion to be connected to or disconnected from the connection position.

As a further improvement of the above technical solution, the latch comprises a latch pin and elastic members which are connected to each other. The latch pin is slidably mounted on the refrigerator body. The spring members are fixedly mounted in the refrigerator body. When the drawer is in an open state, the elastic members naturally extend, and the latch pin is inserted into the connection portion. When the drawer is closed, the body is pressed against the latch pin, the elastic members are compressed, and the latch pin is disconnected from the connection portion. When the drawer is closed, the latch pin is disconnected from the connection portion, and a user can freely open the top cover. When the drawer is open, the latch pin is inserted into the connection portion, and the user cannot open the top cover.

The present invention further provides a control method for a top-opening and rear-opening vehicle-mounted refrigerator, which is used for the top-opening and rear-opening vehicle-mounted refrigerator. In an initial state of the vehicle-mounted refrigerator, neither the top cover nor the drawer is open. When the first sensor detects that the top cover is open, the controller controls the driving mechanism to drive the snap-fit protrusion to be connected to the connection position. When the first sensor detects that the top cover is closed, the controller controls the driving mechanism to drive the snap-fit protrusion to be disconnected from the connection position. When the second sensor senses that the drawer is open, the controller controls the power mechanism to drive the latch tongue to be connected to the connection portion. When the second sensor senses that the drawer is closed, the controller controls the power mechanism to drive the latch tongue to be disconnected from the connection portion. Opening and closing states of the top cover and the drawer are respectively sensed by the first sensor and the second sensor, so as to control the driving mechanism and the power mechanism by means of the controller, thereby controlling the opening and closing states of the top cover and the drawer to prevent the top cover and the drawer from being opened simultaneously.

The beneficial effects of the present invention are that: the top end of the refrigerator body can be opened by means of the top cover, the rear end of the refrigerator body can be opened by means of the drawer, and the top-opening and rear-opening vehicle-mounted refrigerator of the present invention provides convenience for passengers on left, right and rear sides of the refrigerator to take items, i.e., it simultaneously provides convenience for passengers at both front and rear seats to take items in the refrigerator body.

### BRIEF DESCRIPTION OF DRAWINGS

The present invention will be further explained below in conjunction with the description of the accompanying drawings and specific embodiments.

FIG. 1 is a perspective view of a top-opening and rear-opening vehicle-mounted refrigerator of the present invention;

FIG. 2 is an exploded view of an embodiment of the top-opening and rear-opening vehicle-mounted refrigerator of the present invention;

FIG. 3 is an enlarged view of part A in FIG. 2;

FIG. 4 is a perspective view of a top cover of an embodiment of the top-opening and rear-opening vehicle-mounted refrigerator of the present invention;

FIG. 5 is a perspective view of a drawer of an embodiment of the top-opening and rear-opening vehicle-mounted refrigerator of the present invention;

FIG. 6 is an exploded view of another embodiment of the top-opening and rear-opening vehicle-mounted refrigerator of the present invention;

FIG. 7 is a perspective view of a body and a latch of another embodiment of the top-opening and rear-opening vehicle-mounted refrigerator of the present invention; and

FIG. 8 is an enlarged view of Part B in FIG. 7.

In the drawings:
1—refrigerator body, 11—accommodation cavity, 12—slide groove, 13—limiting protrusion, 5—latch, 51—latch pin, 52—elastic member, 4—second sensor, 6—snap-fit member, 3—top cover, 31—connection portion, 2—drawer, 21—body, 211—abutting portion, and 22—connection position.

### DESCRIPTION OF EMBODIMENTS

This section will describe the specific embodiments of the present invention in detail. The preferred embodiments of the present invention are shown in the accompanying drawings. The function of the accompanying drawings is to supplement the statement of the text part of the description with graphics, so that people can intuitively and vividly understand each technical feature and overall technical solution of the present invention. However, the accompanying drawings shall not be construed as a limitation to the protection scope of the present invention.

In the statement of the present invention, it should be understood that orientation statements, such as orientation or position relationships indicated by up, down, front, back, left, right, etc., are based on the orientation or position relationships shown in the accompanying drawings and are only to facilitate the statement of the present invention and simplify the statement, rather than indicate or imply that the device or element referred to must have a specific orientation, be constructed and operate in a specific orientation, and therefore should not be understood as a limitation to the present invention.

In the statement of the present invention, “several” means one or more, “a plurality of” means two or more, “greater than”, “less than”, and “more than”, etc. are understood to exclude the original number, and above, below, within, etc. are understood to include the original number. If there is a statement of first and second, it is only for the purpose of distinguishing technical features, and cannot be understood as indicating or implying the relative importance or implicitly indicating the number of indicated technical features or implicitly indicating the order of indicated technical features.

In the statement of the present invention, unless otherwise explicitly specified, words such as setting, installation, and connection should be understood in a broad sense. Those skilled in the art can reasonably determine the specific meanings of the above words in the present invention in combination with the specific content of the technical solution.

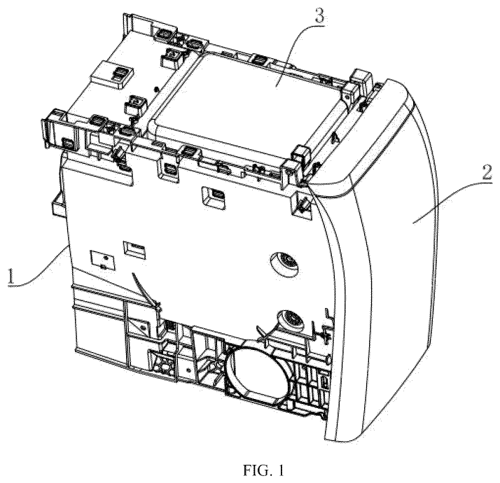

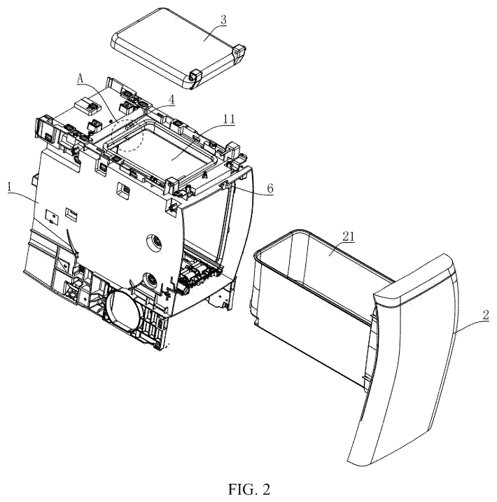

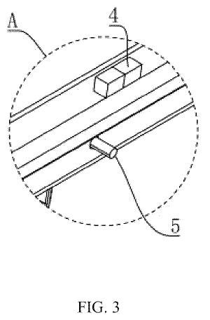

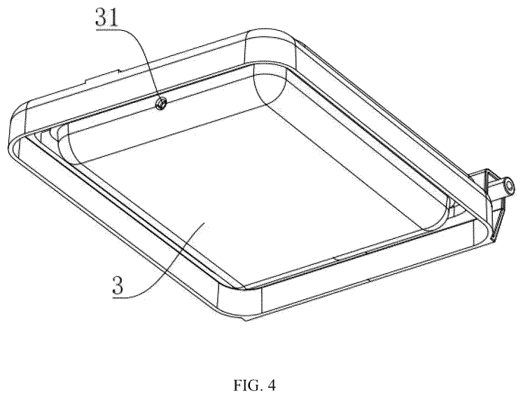

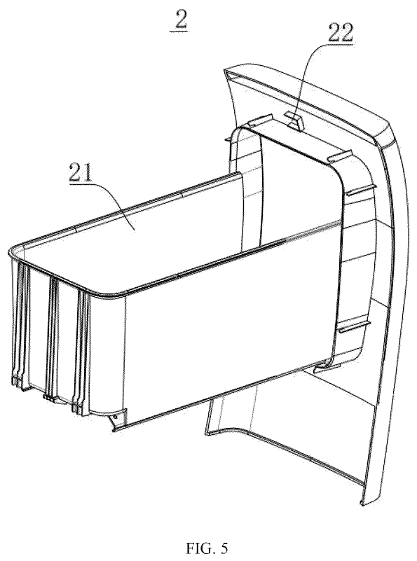

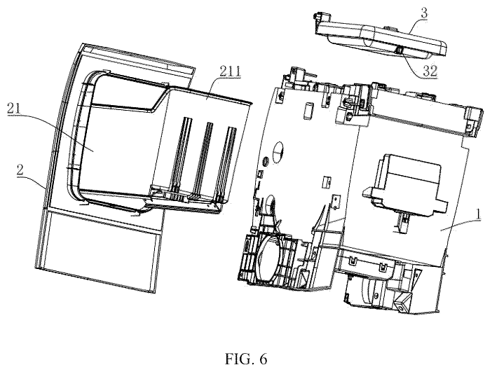

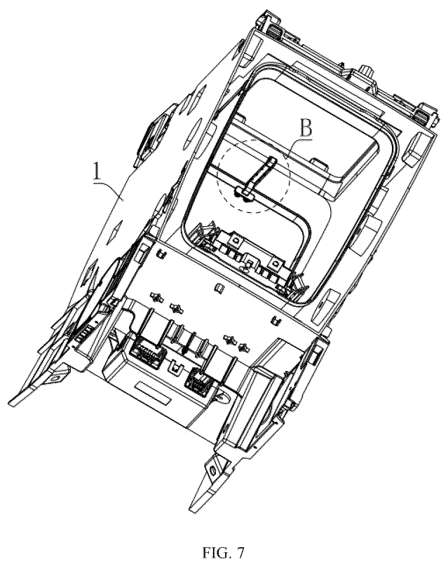

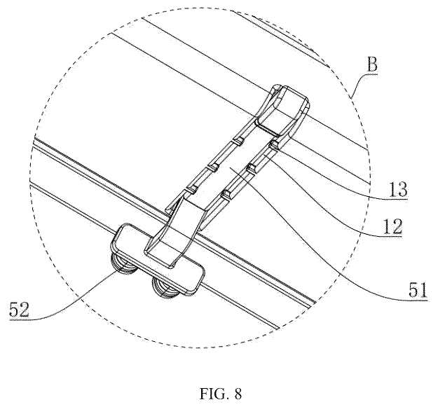

Referring to FIGS. 1 to 8, a top-opening and rear-opening vehicle-mounted refrigerator comprises:

A top-opening and rear-opening vehicle-mounted refrigerator, comprising a refrigerator body 1. A top end and a rear end of the refrigerator body 1 are each provided with an opening. A top cover 3 is arranged at the opening on the top end of the refrigerator body 1. A drawer 2 is further comprised. The drawer 2 comprises a body 21 and a drawer 2 panel. An accommodation cavity 11 is arranged in the refrigerator body 1. The body 21 is arranged in the accommodation cavity 11 and is slidably connected to the refrigerator body 1 in a front-back direction. The drawer 2 panel is connected at the opening on the rear end of the refrigerator body 1 in a covering manner.

In a further preferred embodiment, a rear end of the top cover 3 is hinged to the refrigerator body 1. A front portion of the top cover 3 is provided with a connection portion 31. A latch 5 is arranged on the refrigerator body 1. The latch 5 is detachably connected to the connection portion 31.

In a further preferred embodiment, the latch 5 comprises a latch tongue and a power mechanism (not shown in the drawings). A first sensor (not shown in the drawings) is arranged on the refrigerator body 1. The first sensor is used to sense whether the drawer 2 is open. A controller (not shown in the drawings) is further comprised. The first sensor and the power mechanism are both electrically connected to the controller. The power mechanism is used to drive the latch tongue to be connected to or disconnected from the connection portion 31.

The first sensor may employ a photoelectric sensor, a Hall sensor or the like in the prior art, and the power mechanism may employ an electric motor, an electromagnet or the like in the prior art. A connection between the electric motor and the latch tongue may be a fixed connection, and a connection between the electromagnet and the latch tongue may be a magnetic connection.

In a further preferred embodiment, the first sensor is a Hall sensor. The power mechanism is an electromagnet. The connection portion 31 is a blind hole. The power mechanism can attract or repel the latch tongue, so as to control the latch tongue to translate relative to the connection portion 31, thereby causing the latch tongue to be inserted into or detached from the connection portion 31.

As an optional embodiment, a connection position 22 is arranged on the drawer 2. A snap-fit member 6 is arranged on the refrigerator body 1. The snap-fit member 6 is detachably connected to the connection position 22.

In a further preferred embodiment, the snap-fit member 6 comprises a snap-fit protrusion and a driving mechanism. A second sensor 4 is arranged on the refrigerator body 1. The second sensor 4 is used to sense whether the top cover 3 is open. A controller is further comprised. The second sensor 4 and the driving mechanism are both electrically connected to the controller. The driving mechanism is used to drive the snap-fit protrusion to be connected to or disconnected from the connection position 22.

In a further preferred embodiment, the latch 5 comprises a latch pin 51 and elastic members 52 which are connected to each other. The latch pin 51 is slidably mounted on the refrigerator body 1. The spring members are fixedly mounted in the refrigerator body 1. When the drawer 2 is in an open state, the elastic members 52 naturally extend, and the latch pin 51 is inserted into the connection portion 31. A rear portion of the body 21 extends upward to form an abutting portion 211. When the drawer 2 is closed, the abutting portion 211 is pressed against the latch pin 51, the elastic members 52 are compressed, and the latch pin 51 is disconnected from the connection portion 31. Slide grooves 12 are arranged on the refrigerator body 1. Lower portions of the slide grooves are provided with limiting protrusions 13. The limiting protrusions are used for preventing the latch pin 51 from falling downward, and are arranged between the refrigerator body 1 and a rear end of the latch pin 51.

A control method for a top-opening and rear-opening vehicle-mounted refrigerator is used for a top-opening and rear-opening vehicle-mounted refrigerator.

In an initial state of the vehicle-mounted refrigerator, neither the top cover 3 nor the drawer 2 is open. When the first sensor detects that the top cover 3 is open, the controller controls the driving mechanism to drive the snap-fit protrusion to be connected to the connection position 22. When the first sensor detects that the top cover 3 is closed, the controller controls the driving mechanism to drive the snap-fit protrusion to be disconnected from the connection position 22.

When the second sensor 4 senses that the drawer 2 is open, the controller controls the power mechanism to drive the latch tongue to be connected to the connection portion 31. When the second sensor 4 senses that the drawer 2 is closed, the controller controls the power mechanism to drive the latch tongue to be disconnected from the connection portion 31.

The above are only preferred embodiments of the present invention, and are not intended to limit the patent scope of the present invention. Under the inventive concept of the present invention, equivalent structural transformations made using the contents of the description and drawings of the present invention, or directly or indirectly used in other relevant technical fields are all included in the patent protection scope of the present invention.

What is claimed is:

1. A top-opening and rear-opening vehicle-mounted refrigerator, comprising a refrigerator body (1), wherein
a top end and a rear end of the refrigerator body (1) are each provided with an opening;
a top cover (3) is arranged at the opening on the top end of the refrigerator body (1);
a drawer (2) is further comprised, the drawer (2) comprises a body (21) and a drawer panel, an accommodation cavity (11) is arranged in the refrigerator body (1), the body (21) is arranged in the accommodation cavity (11) and is slidably connected to the refrigerator body (1) in a front-back direction, and the drawer panel is connected at the opening on the rear end of the refrigerator body (1) in a covering manner.

2. The top-opening and rear-opening vehicle-mounted refrigerator according to claim 1, wherein
a rear end of the top cover (3) is hinged to the refrigerator body (1), a front portion of the top cover (3) is provided with a connection portion (31), a latch (5) is arranged on the refrigerator body (1), and the latch (5) is detachably connected to the connection portion (31).

3. The top-opening and rear-opening vehicle-mounted refrigerator according to claim 2, wherein
the latch (5) comprises a latch tongue and a power mechanism, a first sensor is arranged on the refrigerator body (1), the first sensor is used to sense whether the drawer (2) is open, a controller is further comprised, the first sensor and the power mechanism are both electrically connected to the controller, and the power mechanism is used to drive the latch tongue to be connected to or disconnected from the connection portion (31).

4. The top-opening and rear-opening vehicle-mounted refrigerator according to claim 3, wherein
the first sensor is a Hall sensor, the power mechanism is an electromagnet, the connection portion (31) is a blind hole, and the power mechanism can attract or repel the latch tongue, so as to control the latch tongue to translate relative to the connection portion (31), thereby causing the latch tongue to be inserted into or detached from the connection portion (31).

5. The top-opening and rear-opening vehicle-mounted refrigerator according to claim 3, wherein
a connection position (22) is arranged on the drawer (2), a snap-fit member (6) is arranged on the refrigerator body (1), and the snap-fit member (6) is detachably connected to the connection position (22).

6. The top-opening and rear-opening vehicle-mounted refrigerator according to claim 5, wherein
the snap-fit member (6) comprises a snap-fit protrusion and a driving mechanism, a second sensor (4) is arranged on the refrigerator body (1), the second sensor (4) is used to sense whether the top cover (3) is open, a controller is further comprised, the second sensor (4) and the driving mechanism are both electrically connected to the controller, and the driving mechanism is used to drive the snap-fit protrusion to be connected to or disconnected from the connection position (22).

7. The top-opening and rear-opening vehicle-mounted refrigerator according to claim 2, wherein
the latch (5) comprises a latch pin (51) and elastic members (52) which are connected to each other, the latch pin (51) is slidably mounted on the refrigerator body (1), and the spring members are fixedly mounted in the refrigerator body (1);
when the drawer (2) is in an open state, the elastic members (52) naturally extend, and the latch pin (51) is inserted into the connection portion (31); and when the drawer (2) is closed, the body (21) is pressed against the latch pin (51), the elastic members (52) are compressed, and the latch pin (51) is disconnected from the connection portion (31).

8. A control method for a top-opening and rear-opening vehicle-mounted refrigerator, which is used for the top-opening and rear-opening vehicle-mounted refrigerator according to claim 6, wherein
in an initial state of the vehicle-mounted refrigerator, neither the top cover (3) nor the drawer (2) is open; when the first sensor detects that the top cover (3) is open, the controller controls the driving mechanism to drive the snap-fit protrusion to be connected to the connection position (22); when the first sensor detects that the top cover (3) is closed, the controller controls the driving mechanism to drive the snap-fit protrusion to be disconnected from the connection position (22);
when the second sensor (4) senses that the drawer (2) is open, the controller controls the power mechanism to drive the latch tongue to be connected to the connection portion (31); and when the second sensor (4) senses that the drawer (2) is closed, the controller controls the power mechanism to drive the latch tongue to be disconnected from the connection portion (31).
